(19) United States
(12) Patent Application Publication
(10) Pub. No.: US 2026/0059561 A1
(43) Pub. Date: Feb. 26, 2026

(54) SENSING RESULTS SHARING FROM LTE SIDELINK TO NR SIDELINK

(71) Applicant: Apple Inc., Cupertino, CA (US)

(72) Inventors: Chunxuan Ye, San Diego, CA (US); Ankit Bhamri, Bad Nauheim (DE); Chunhai Yao, Beijing (CN); Dawei Zhang, Saratoga, CA (US); Hong He, San Jose, CA (US); Huaning Niu, San Jose, CA (US); Oghenekome Oteri, San Diego, CA (US); Peng Cheng, Beijing (CN); Wei Zeng, Saratoga, CA (US); Zhibin Wu, Los Altos, CA (US)

(21) Appl. No.: 19/101,817

(22) PCT Filed: Aug. 12, 2022
(86) PCT No.: PCT/CN2022/111955

§ 371 Date: Feb. 6, 2025

(51) Int. Cl. H04W 72/40; H04W 72/541

(52) U.S. Cl. CPC H04W 72/40; H04W 72/541

(57) ABSTRACT

A processor having circuitry to execute instructions is disclosed. The instructions perform operations that include obtaining sensing information using a first circuitry of a UE, the first circuitry configured to perform a first sidelink communication of a first technology. The operations include sharing the sensing information obtained using the first circuitry with a second circuitry of the UE, the second circuitry configured to perform a second sidelink communication of a second technology. The operations include obtaining inter-UE coordination information from a coordinating UE. The operations include identifying a pool of candidate resources based at least on the shared sensing information and the inter-UE coordination information. The operations include selecting, from the pool of candidate resources, a resource for the second sidelink communication.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation (5G) New Radio (NR). The wireless communication networks facilitate mobile broadband service using technologies such as OFDM, multiple input multiple output (MIMO), advanced channel coding, massive MIMO, beamforming, and/or other features.

In some wireless communications networks, a user equipment (UE) may communicate with another UE without having the communication routed through a network node, using what is referred to as sidelink communication. A transmitting UE that initiates sidelink communication may determine the available resources (e.g., sidelink resources) and may select a subset of these resources to communicate with a receiving UE based on a resource allocation scheme. Existing protocols support sidelink communication using Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the transmitting UE selects the sidelink resources (e.g., sidelink transmission resources). A UE performing Mode 2 resource allocation for sidelink communication may further be assisted by another UE in a mechanism referred to as “Inter-UE Coordination” (IUC). In IUC, a coordinating UE sends coordination information to assist the transmitting UE that initiates sidelink communication. Along with resource allocation with or without IUC, the transmitting UE may consider a selected resource as either “preferred” or “non-preferred.”

### SUMMARY

In accordance with one aspect of the present disclosure, a processor includes circuitry to execute one or more instructions that perform operations. The operations include obtaining sensing information using a first circuitry of a UE, the first circuitry configured to perform a first sidelink communication of a first technology. The operations include sharing the sensing information obtained using the first circuitry with a second circuitry of the UE, the second circuitry configured to perform a second sidelink communication of a second technology. The operations include obtaining IUC information from a coordinating UE. The operations include identifying a pool of candidate resources based at least on the shared sensing information and the IUC information. The operations further include selecting, from the pool of candidate resources, a resource for the second sidelink communication.

In some implementations, selecting the resource from the pool of candidate resources includes excluding one or more candidate resources from the pool based on one or more criteria. The one or more criteria can include: a measured Reference Signal Received Power (RSRP) value of the one or more candidate resources being higher than a threshold value; the shared sensing information indicating that the one or more candidate resources are reserved; or a total number of candidate resources in the pool after exclusion being greater than a predetermined number.

In some implementations, the IUC includes an indication of a preferred resource. The operations further include identifying the pool of candidate resources as including the preferred resource. Selecting the resource from the pool of candidate resources includes: prioritizing the preferred resource over other candidate resources in the pool in the selection.

In some implementations, the IUC includes an indication of a non-preferred resource. The operations further include identifying the pool of candidate resources as including the non-preferred resource.

In some implementations, the first technology is LTE and the second technology is NR.

In accordance with one aspect of the present disclosure, a processor includes circuitry to execute one or more instructions that perform operations. The operations include allocating a pool of resources based on frequency division multiplexing (FDM) for performing a first sidelink communication of a first technology and a second sidelink communication of a second technology. The operations include partitioning the pool into a first resource pool and a second resource pool, wherein the first resource pool and the second resource pool are separated by a guard band. The operations include instructing a UE to perform the first sidelink communication using the first resource pool and instructing the UE to perform the second sidelink communication using the second resource pool.

In some implementations, the first sidelink communication and the second sidelink communication have different subcarrier spacings.

In some implementations, the second sidelink communication includes transmission in a physical sidelink feedback channel (PSFCH) within a slot.

In some implementations, the operations include instructing the UE to perform automatic gain control (AGC).

In some implementations, the operations include receiving configuration information that indicates an initial partition of the pool of resources. Partitioning the pool into a first resource pool and a second resource pool includes determining a size of the guard band and modifying the initial partition according to size of the guard band.

In some implementations, the first technology is LTE and the second technology is NR.

In accordance with one aspect of the present disclosure, a UE includes a transceiver and a processor. The processor allocates a pool of resources based on FDM for performing a first sidelink communication of a first technology and a second sidelink communication of a second technology. The processor partitions the pool into a first resource pool and a second resource pool, the first resource pool and the second resource pool being separated by a guard band. The transceiver performs the first sidelink communication using the first resource pool and performs the second sidelink communication using the second resource pool.

In some implementations, the first sidelink communication and the second sidelink communication have different subcarrier spacings.

In some implementations, the second sidelink communication includes transmission in a PSFCH within a slot.

In some implementations, the operations include instructing the UE to perform AGC.

In some implementations, the transceiver further receives configuration information that indicates an initial partition of the pool of resources. In partitioning the pool into a first resource pool and a second resource pool, the processor determines a size of the guard band and modifies the initial partition according to size of the guard band.

In some implementations, the first technology is LTE and the second technology is NR.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system 100, according to some implementations.

FIG. 2 illustrates an example sidelink resource selection procedure for NR communication, according to some implementations.

FIG. 3A illustrates an example sensing resource sharing procedure, according to some implementations.

FIG. 3B illustrates another example sensing resource sharing procedure, according to some implementations.

FIG. 4A illustrates an example timing diagram of sensing result sharing, according to some implementations.

FIG. 4B illustrates an example timing diagram of determining a reference slot, according to some implementations.

FIG. 5A illustrates time division multiplexing (TDM)-based semi-static resource pool partitioning between LTE and NR sidelink communications, according to some implementations.

FIG. 5B illustrates FDM-based semi-static resource pool partitioning between LTE and NR sidelink communications, according to some implementations.

FIG. 5C illustrates dynamic resource sharing between LTE and NR sidelink communications, according to some implementations.

FIG. 6A illustrates an example of partial sub-channel overlap between LTE and NR sidelink communications, according to some implementations.

FIG. 6B illustrates another example of partial sub-channel overlap between LTE and NR sidelink communications, according to some implementations.

FIG. 7A illustrates an example method of using a guard band in FDM-based semi-static resource pool partitioning between LTE and NR sidelink communications, according to some implementations.

FIG. 7B illustrates another example method of using a guard band in FDM-based semi-static resource pool partitioning between LTE and NR sidelink communications, according to some implementations.

FIG. 8 illustrates an example resource pool re-turning procedure for NR sidelink communication, according to some implementations.

FIG. 9 illustrates a flowchart of an example method 900 of sharing sensing results within a UE for sidelink communications, according to some implementations.

FIG. 10 illustrates a flowchart of an example method 1000 of resource selection based on shared sensing results and IUC information, according to some implementations.

FIG. 11 illustrates a flowchart of an example method 1100 of resource pool partitioning, according to some implementations.

FIG. 12 illustrates a UE, according to some implementations.

FIG. 13 illustrates an access node, according to some implementations.

### DETAILED DESCRIPTION

A UE can perform sidelink communications using different technologies, such as LTE and NR. Because of the limited frequency spectrums available to LTE and NR sidelink communications, the two sidelink communications need to coordinate their use of resources to achieve what is referred to as “co-channel coexistence.” Co-channel coexistence of LTE and NR sidelink communications means that the same UE can perform LTE and NR sidelink communications on the same frequency channel (referred to as “sidelink channel”) during the same period.

In cases of LTE and NR co-channel coexistence, the sidelink resources can be allocated by semi-static resource pool partitioning or dynamic resource sharing. In semi-static resource pool partitioning, the available resources (referred to as “resource pool”) are pre-partitioned, by time (e.g., TDM-based) or by frequency (e.g., FDM-based), into an LTE resource pool and an NR resource pool that do not overlap. In dynamic resource sharing, the same resource pool is made available for both LTE and NR communications; whether a particular resource is assigned for LTE or NR is dynamically decided during communication.

In Mode 2 resource allocation scheme, the UE initiating the sidelink communication selects the sidelink resources. When the UE wants to initiate an NR sidelink communication while performing a co-channel coexisting LTE sidelink communication, the LTE communication module (i.e., the UE circuitry that controls LTE communication) can share sensing results with the NR communication module (i.e., the UE circuitry that controls NR communication) so the UE can allocate resources for both communications. Here, sensing results can include (i) measurement results, such as RSRP, on the sidelink channel, or (ii) decoding results of sidelink control information (SCI) received from the sidelink channel. The sensing results shared by the LTE communication module can help the NR communication module determine resources and configurations for performing the NR sidelink communication.

While sensing results sharing from the LTE communication module to the NR communication module can improve NR sidelink communication performance, there remain a number of issues to be resolved. For example, the UE needs to determine when to share the sensing results so the NR communication module can timely utilize the shared information. Also, the same sidelink channel can be divided into a number of LTE sub-channels for the LTE sidelink communication and can be divided into a number of NR sub-channels for the NR sidelink communication. An LTE sub-channel thus can possibly overlap an NR sub-channel. In order to determine the availability of an NR channel for NR sidelink communication, the NR communication module needs to know whether the NR sub-channel is occupied by the coexisting LTE communication using an overlapping LTE sub-channel. In addition, in situations of IUC, the NR communication module has two sources of resource selection, potentially competing: the shared sensing results from the LTE communication module; and the coordination information from the coordinating UE. As such, the NR communication module needs a mechanism to handle resource selection based on both sources of information. Furthermore, the UE sometimes needs to calculate channel busy ratio (CBR) of a sidelink communication. With LTE and NR co-channel coexistence, the UE needs to determine how CBR calculation for the NR communication accounts for the resources indicated as busy in the LTE sensing results. Finally, in scenarios of FDM-based semi-static resource pool partitioning, the UE can apply AGC to received signals so the signal power is maintained within a certain range. When the UE adjusts the power of a received NR signal in a slot, the adjustment could inadvertently cause interference to the LTE signal received at a neighboring frequency. Thus, the UE needs to implement a mechanism to reduce the interference.

This disclosure provides solutions to one or more of the above issues. With the features described below, the NR communication module can effectively utilize the sensing results shared by the LTE communication module, and the UE can reliably handle the co-channel coexistence of LTE and NR sidelink communications.

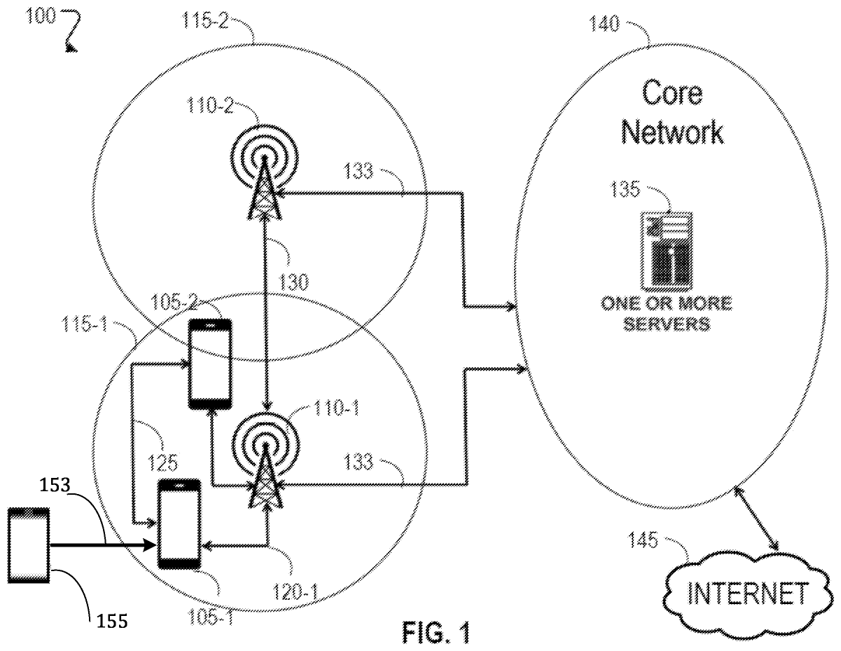

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with 5G networks as provided by 3GPP technical specifications. However, the example implementations are not limited in this regard and the described examples may apply to other networks that may benefit from the principles described herein, such as 3GPP LTE networks, Wi-Fi or Worldwide Interoperability for Microwave Access (WiMaX) networks, and the like. Furthermore, other types of communication standards are possible, including future 3GPP systems (e.g., Sixth Generation (6G)), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain embodiments, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), PSFCH, and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and road side units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In the communication system 100, UE 105-1 may initiate sidelink communication with UE 105-2. Although the sidelink communication in FIG. 1 involves two UEs only, a UE initiating sidelink communication may communicate with more than one UEs via sidelink. Moreover, in situations of IUC, UE 105-1 may further receive coordination information 153 from a coordinating UE 155. UE 155 may be structurally and/or functionally similar to UEs 115. For example, UE 155 may also include a transmitter/receiver, memory, one or more processors, and one or more antenna elements. UE 155 may use these components to transmit coordination information 153 to one or more of UEs 105. The description below assumes that the LTE and NR sidelink communications are initiated by UE 105-1.

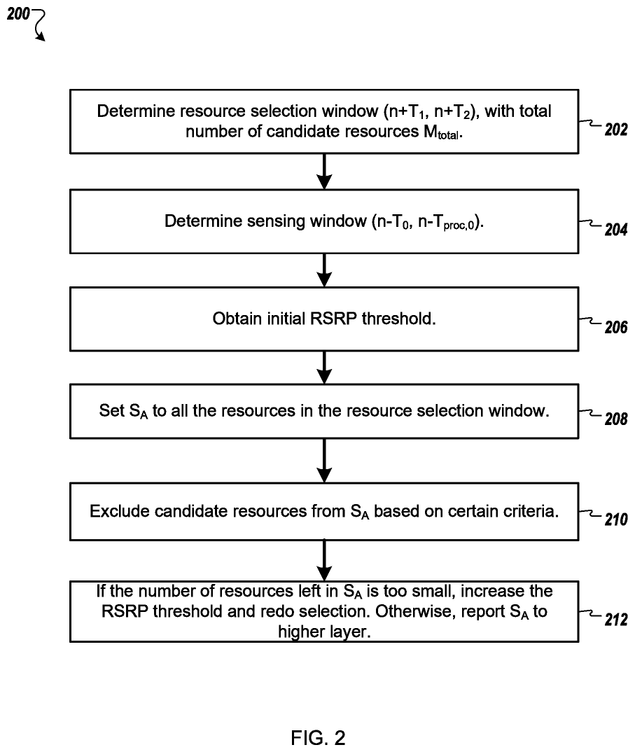

FIG. 2 illustrates an example sidelink resource selection procedure 200 for NR communication, according to some implementations. Procedure 200 applies to Mode 2 resource allocation scheme. According to procedure 200, the NR communication module first identifies all candidate resources SA available during a time window, and then exclude certain candidate resources from SA until all remaining candidate resources can be used for the NR sidelink communication. Procedure 200 describes the operations of the NR communication module only, without considering co-channel coexistence of an LTE sidelink communication. In scenarios of co-channel coexistence of an LTE sidelink communication, one or more operations in procedure 200 may be modified. Procedure 200 thus provides a baseline for UEs under various configurations to select sidelink resources, whether or not there is sensing results sharing.

Specifically, at 202, the NR communication module determines a time window for resource selection, represented as (n+T₁, n+T₂). In this example, n denotes a trigger time for resource selection, and n+T₁ and n+T₂ denote the start and the end, respectively, of the resource selection window. The values of n, T₁ and T₂ can be set by UE 105-1. Also at 202, the NR communication module determines a total number Mₜₒₜₐₗ of candidate resources available during the resource selection window.

At 204, the NR communication module determines time window for performing its own sensing. The sensing typically occurs prior to the resource selection window determined at 202 because the NR communication module needs time to process the sensing results before selecting resources. In scenarios with co-channel coexistence of LTE sidelink communication where the NR communication module uses sensing results shared by the LTE communication module, 204 may be modified or omitted.

At 206, the NR communication module obtains an initial threshold value of RSRP. The RSRP threshold value is later used as one of the criteria to exclude some candidate resources from S_{A}.

At 208, the NR communication module sets S_{A} to include all of the resources available during the resource selection window. That is, all of the resources available during the resource selection window are initially candidate resources.

At 210, the NR communication module excludes some candidate resources from S_{A} based on some criteria. The exclusion may be based on, e.g., whether a candidate resource is timely sensed in the sensing window, whether a candidate resource is reserved according to SCI, or whether the measured RSRP of the candidate resource is higher than the RSRP threshold value.

At 212, the NR communication module determines whether the number of remaining candidate resources in S_{A} is too small for the NR sidelink communication, e.g., smaller than Mₜₒₜₐₗ multiplied by a predetermined coefficient. If so, then the NR communication module needs to change the exclusion criteria so more candidate resources can be kept in S_{A}. One way of changing the exclusion criteria is to increase the RSRP threshold value by 3 dB and redo 210. If the number of remaining candidate resources in S_{A} is sufficient for the NR sidelink communication, then the NR communication module reports the S_{A} to higher layer of UE 105-1.

When there is co-channel coexistence of LTE sidelink communication with NR sidelink communication, the NR communication module can use the sensing results of the LTE communication module rather than performing its own sensing. The NR communication module can determine to use shared LTE sensing results following several procedures.

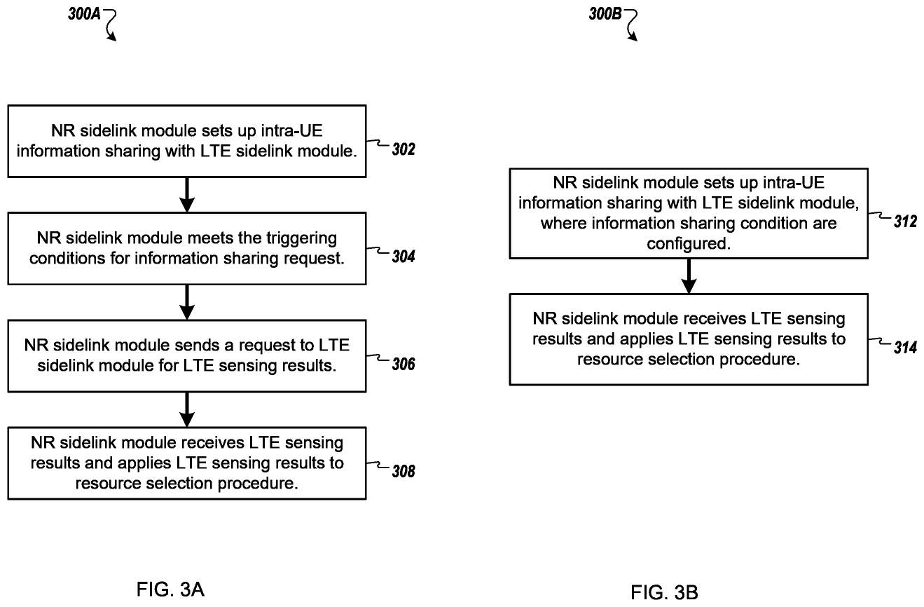

FIG. 3A illustrates an example sensing resource sharing procedure 300A, according to some implementations. Procedure 300A is based on a request expressly sent from the NR communication module to the LTE communication module. When configured to perform sensing results sharing under procedure 300A, the NR communication module of UE 105-1 can reliably control the timing to request LTE sensing results while potentially reducing wait time for the LTE sensing results.

Specifically, at 302, the NR communication module sets up intra-UE information sharing with the LTE sidelink module. For example, the NR communication module is configured to allow using the LTE sensing results for resource selection and the LTE communication module is configured to allow sharing sensing results with the NR communication module.

At 304, the NR communication module determines a condition is met. The condition triggers the NR communication module to send a request for sensing results sharing to the LTE communication module.

At 306, the NR communication module sends the request to the LTE communication module.

At 308, the NR communication module receives LTE sensing results from the LTE communication module. The NR communication module then applies the LTE sensing results to its own resource selection procedure, which can be similar to 206-212 of FIG. 2.

FIG. 3B illustrates another example sensing resource sharing procedure 300B, according to some implementations. Different from procedure 300A, procedure 300B is based on a pre-configured condition for sensing results sharing without an expressly sent request from the NR communication module to the LTE communication module. When configured to perform sensing results sharing under procedure 300A, the NR communication module of UE 105-1 can obtain the LTE sensing results without sending an express request. This can reduce the complexity of communication between the LTE communication module and the NR communication module.

Specifically, at 312, the NR communication module sets up intra-UE information sharing with the LTE sidelink module. Meanwhile, UE 105-1 configures the LTE communication module and the NR communication module with a condition that triggers sensing results sharing.

At 314, upon the condition be met, the LTE communication module shares its sensing results to the NR communication module. Upon receiving the shared sensing results, the NR communication module applies the LTE sensing results to its own resource selection procedure.

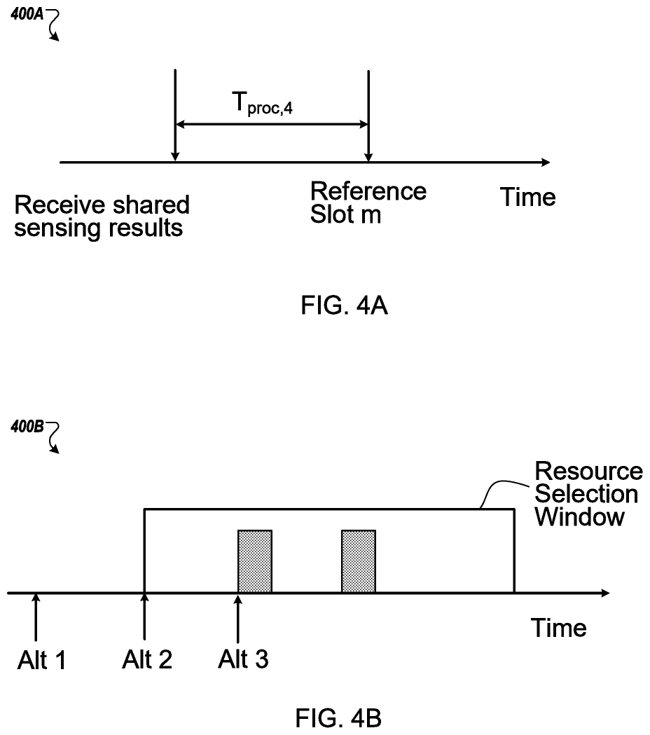

FIG. 4A illustrates an example timing diagram 400A of sensing result sharing, according to some implementations. UE 105-1 can configure the LTE communication module and the NR communication module based on timing diagram 400A to control the time of sharing LTE sensing results. As discussed below, FIG. 4A, along with FIG. 4B, provides a mechanism for UE 105-1 to determine the timing to share sensing results from the LTE communication module to the NR communication module so that the NR communication can select resources using the shared sensing results.

As mentioned previously, the NR communication module needs time to process the shared sensing results before making resource selection. Accordingly, timing diagram 400A introduces a processing time offset T_{proc,4}, to measure a time period before a given slot (“reference slot”) m. Timing diagram 400A thus requires all sensing results corresponding to reference slot m be received by the NR communication module no later than (m−T_{proc,4}). If the sensing results are received later than (m−T_{proc,4}), the NR communication module may not use the sensing results.

In some implementations, the value of T_{proc,4} can be predefined by UE 105-1.

In some implementations, the value of T_{proc,4} can be determined as (T_{proc,0}+T_{proc,1}), where T_{proc,0} and T_{proc,1} each represent a processing time parameter defined in existing 3GPP standards. For example, T_{proc,0} can represent the time for UE 105-1 to handle the sensing results, while T_{proc,1} can represent the time for UE 105-1 to prepare sidelink transmission. Alternatively, in some implementations, the value of T_{proc,4} can be determined as (T_{proc,1}+T_{additional}), where T_{additional} can represent additional processing time needed by UE 105-1 to interpret the shared sensing results.

In some implementations, the value of T_{proc,4} can be determined based on subcarrier spacing of the NR sidelink communication. For example, the larger the sub-carrier spacing, the larger the value of T_{proc,4}.

In some implementations, the value of T_{proc,4} can be determined based on a capability of UE 105-1.

In some implementations, the value of T_{proc,4} can be subject to an upper bound of a time gap. In an example, the upper bound is pre-defined to be 4 ms. As such, UE 105-1 can configure the value of T_{proc,4} to be less than or equal to 4 ms.

FIG. 4B illustrates an example timing diagram 400B of determining a reference slot m, according to some implementations. As described above, the time of reference slot m determines the time for the NR communication module to receive or the time by which the NR communication module should receive the shared sensing results. A variety of options are available for determining the time of reference slot m. Several examples of these options are illustrated in FIG. 4B as Alt 1, Alt 2 and Alt 3 with reference to the resource selection window.

In some implementations corresponding to Alt 1, reference slot m can equal the slot when the NR communication module triggers the resource selection (or resource re-selection, resource re-evaluation, resource pre-emption). For example, reference slot m can equal n described in 202 of FIG. 2.

In some implementations corresponding to Alt 2, reference slot m can occur at the starting time of the resource selection window (n+T₁). In scenarios where sensing result sharing is based on a request from the NR communication module, the occurring time of reference slot m can be indicated to the LTE communication module along with the request.

In some implementations corresponding to Alt 3, reference slot m can be determined based on the shared LTE sensing results. For example, when LTE sensing results indicate one or more resources within the resource selection window, reference slot m can be determined to occur at the time of the first non-preferred resource indicated in the LTE sensing results.

In some implementations other than Alt 1, Alt 2, and Alt 3, reference slot m can occur at the end of the sensing window during which the LTE communication module obtains the sensing results. These sensing results must be received by the NR communication module to be timely processed. The latest time the sensing results can be received is denoted as (m+T_{proc,5}), where T_{proc,5} represents the maximum possible delay after the sensing window for the sensing results to be shared with the NR communication module.

With the features described above, the LTE communication module and the NR communication module can accurately determine the time for sharing the sensing results and making arrangement for NR resource selection. This can advantageously improve efficiency and reliability of sidelink communication.

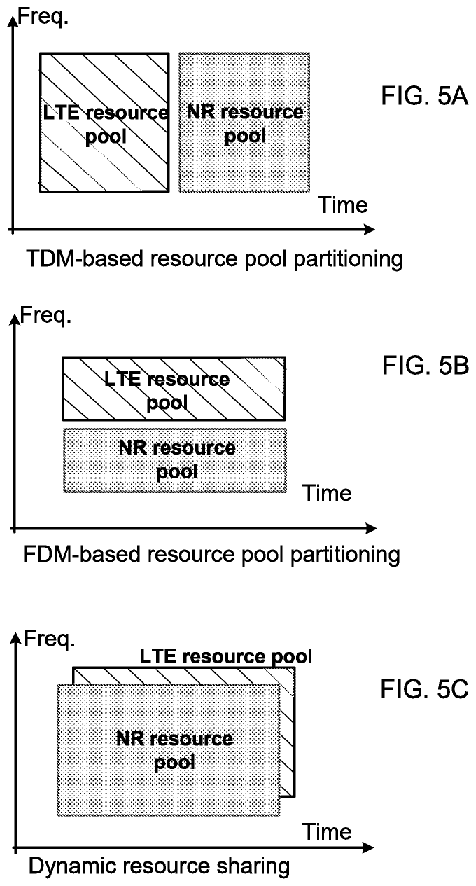

As previously discussed, sidelink resources can be allocated by semi-static resource pool partitioning or dynamic resource sharing. In semi-static resource pool partitioning, the available resources are pre-partitioned between LTE and NR, so the NR resource selection does not need to consider the LTE resource pool. In dynamic resource sharing, the same resource pool is made available for both LTE and NR communications, so the NR communication module needs to consider the LTE resources when selecting resources for NR sidelink communication. Semi-static resource pool partitioning and dynamic resource sharing are shown in FIGS. 5A-5C.

FIG. 5A illustrates TDM-based semi-static resource pool partitioning between LTE and NR sidelink communications, according to some implementations. In this mechanism, the LTE resource pool and the NR resource pool overlap in frequency while occupying different time.

FIG. 5B illustrates FDM-based semi-static resource pool partitioning between LTE and NR sidelink communications, according to some implementations. In this mechanism, the LTE resource pool and the NR resource pool overlap in time while occupying different frequency bands.

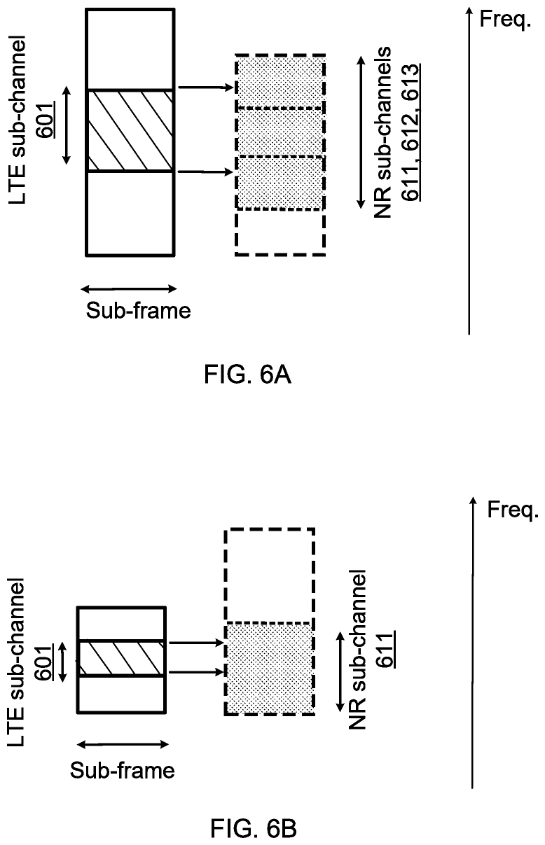

FIG. 5C illustrates dynamic resource sharing between LTE and NR sidelink communications, according to some implementations. In this mechanism, the LTE resource pool and the NR resource pool share the same time and frequency resources. From the LTE sensing results, the NR communication module can know which LTE resources are in use. To avoid conflict, the NR communication module needs to make sure the resources for NR sidelink communication are not already occupied by the LTE sidelink communication. Some implementations to address the potential conflict of resources between LTE and NR are described below with reference to FIGS. 6A and 6B.

FIG. 6A illustrates an example of partial sub-channel overlap between LTE and NR sidelink communications, according to some implementations. As shown in FIG. 6A, a sub-frame of the LTE sidelink communication occupies an LTE sub-channel 601. On the other side, the NR communication module needs to determine whether the three NR sub-channels 611, 612, 613, which partially or entirely overlap LTE sub-channel 601, can be used for NR sidelink communication.

FIG. 6B illustrates another example of partial sub-channel overlap between LTE and NR sidelink communications, according to some implementations. As shown in FIG. 6A, a sub-frame of the LTE sidelink communication occupies an LTE sub-channel 601. On the other side, the NR communication module needs to determine whether NR sub-channel 611, which overlaps a part of LTE sub-channel 601, can be used for NR sidelink communication.

In view of the situations in FIGS. 6A and 6B, the NR communication module can utilize a number of rules to determine whether an NR sub-channel is occupied, and thus made unavailable, by the LTE sidelink communication.

In some implementations, the NR communication module can consider an NR sub-channel occupied as long as the NR sub-channel overlaps an LTE sub-channel. Under this rule, NR sub-channels 611, 612, 613 in FIGS. 6A and 611 in FIG. 6B are all considered occupied and unavailable for NR sidelink communication.

In some implementations, the NR communication module can consider an NR sub-channel occupied if the NR sub-channel has more than A physical resource blocks (PRBs) overlapping an LTE sub-channel, where A represents a number pre-configured for each resource pool. For example, assume NR sub-channels 611, 612, 613 in FIG. 6A have 10 PRBs, 30 PRBs, and 10 PRBs, respectively, that overlap LTE sub-channel 601. If A=5, then all NR sub-channels 611, 612, 613 in FIG. 6A are considered occupied. If A=15, then NR sub-channels 611 and 613 in FIG. 6A are considered unoccupied while NR sub-channel 612 is considered occupied.

In some implementations, the NR communication module can consider whether an NR sub-channel is occupied based on a ratio of (i) the number of PRBs in the NR sub-channel that overlap an LTE sub-channel, over (ii) the total number of PRBs in the NR sub-channel. If the ratio is greater than B, where B represents a threshold pre-configured for each resource pool, then the NR sub-channel is considered occupied; otherwise, the NR sub-channel is considered unoccupied. For example, assume NR sub-channels 611, 612, 613 in FIG. 6A each have 30 PRBs in total, and assume these NR sub-channels 611, 612, 613 have 10 PRBs, 30 PRBs, and 10 PRBs, respectively, that overlap LTE sub-channel 601. The ratio for NR sub-channels 611, 612, 613 can thus be calculated as 33%, 100%, and 33%, respectively. If B=20%, then all NR sub-channels 611, 612, 613 are considered occupied. If B=40%, then NR sub-channels 611 and 613 in FIG. 6A are considered unoccupied while NR sub-channel 612 is considered occupied.

With the features described above, the NR communication module can accurately determine the availability of a frequency resource. This can advantageously improve resource utilization and avoid conflict in sidelink communications with LTE and NR co-channel coexistence.

In some implementations, if the NR communication module determines a resource as occupied and unavailable based on LTE sensing results, the NR communication module excludes, e.g., in 210 of FIG. 2, the occupied resource from the set of candidate resources S_{A}. In the event the exclusion would lead to too few available resources in S_{A} for NR sidelink communication, UE 105-1 can determine, according to its own implementation and/or resource pool configuration or preconfiguration, whether to take into account the shared LTE sensing results. That is, if using LTE sensing results would cause the NR communication module to exclude too many resources such that there would not be sufficient resources for the NR sidelink communication, UE 105-1 can possibly be configured not to use the shared LTE sensing results in order to select sufficient resources.

In some implementations where IUC is available, UE 105-1 can make resource selection based on both the shared LTE sensing results and the coordination information 153 from the coordinating UE 155.

Specifically, if the coordination information 153 indicates to UE 105-1 a non-preferred resource set, the resources in the non-preferred resource set are included in the initial candidate resources S_{A} and are subject to similar exclusion, as described in 208-212 of FIG. 2. In the event the exclusion would lead to too few available resources in S_{A} for NR sidelink communication, UE 105-1 can determine, according to its own implementation and/or resource pool configuration or preconfiguration, whether to take into account the shared LTE sensing results, the IUC-indicated non-preferred resource set, or both.

Conversely, if the coordination information 153 indicates to UE 105-1 a preferred resource set, then the resources indicated in the shared LTE sensing results are treated as non-preferred resources, subject to the exclusion as described in 208-212 of FIG. 2. UE 105-1 can determine, according to its own implementation, how to use the resources included in the IUC-indicated preferred resource set.

With the features described above, UE 105-1 can efficiently utilize not only the shared LTE sensing results but also coordination information 153 from coordinating UE 155. This would advantageously improve the resource selection procedure for NR sidelink communication.

In sidelink communications, CBR is often used as a metric to measure channel load perceived by a sidelink device. CBR is calculated as a ratio between the time a channel is sensed as busy and the total observation time of the channel. In some implementations, a channel is sensed as busy if received signal strength indicator (RSSI) measurement is greater than an RSRP threshold of the channel. When the NR communication module uses shared LTE sensing results to perform NR sidelink communication, the NR communication module needs to know how to account for the resources indicated as busy in the LTE sensing results.

In some implementations, resources sensed as busy by the LTE communication module are always counted as busy by the NR communication module.

In some implementations, resources sensed as busy by the LTE communication module are not counted as busy by the NR communication module.

In some implementations, whether resources sensed as busy by the LTE communication module are counted as busy by the NR communication module is determined based on a resource pool configuration or reconfiguration. For example, the determination could be based on one or more parameters set by UE 105-1, based on the resource in question, or based on the LTE sensing results.

With the features described above, the NR communication module can know how to calculate CBR for NR sidelink communication based on the sensing results shared by a co-channel coexisting LTE sidelink communication.

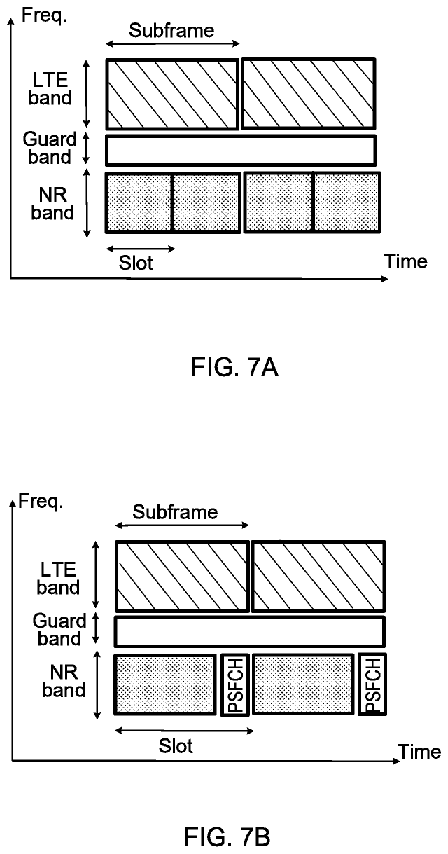

Sidelink resources can be allocated by semi-static resource pool partitioning, which can be TDM-based or FDM-based. In FDM-based semi-static resource pool partitioning as previously described with reference to FIG. 5B, the LTE resource pool and the NR resource pool overlap in time while occupying different frequency bands. However, when UE 105-1 applies AGC to received signals, an adjustment of an NR signal reception power could inadvertently interfere the LTE signal simultaneously received at a neighboring frequency band. This problem, as well as implementations to solve the problem, is discussed with reference to FIGS. 7A and 7B.

FIGS. 7A and 7B each illustrate an example method of using a guard band in FDM-based semi-static resource pool partitioning between LTE and NR sidelink communications, according to some implementations. In FIGS. 7A and 7B, a number of LTE subframes occupying an LTE band (i.e., LTE sidelink resource pool) coexist with a number of NR slots occupying an NR band (i.e., NR sidelink resource pool) in the same time period. As explained below, implementations with a guard band between the LTE band and the NR band can reduce interference between the LTE communication and the NR communication caused by AGC.

In LTE and NR, the length of a slot depends on subcarrier spacing, also known as numerology. While LTE supports only one subcarrier spacing and thus only one slot length, NR communication can choose from multiple subcarrier spacings and thus multiple slot lengths. Depending on NR sidelink communication's choice of subcarrier spacing, it is possible that multiple NR slots overlap a single LTE subframe in time in some implementations. For example, in FIG. 7A, two NR slots overlap each LTE subframe in time. Because the received signal power may differ for each NR slot, UE 105-1 may need to adjust the power on the receiving antenna by performing AGC in the middle of an LTE subframe. This can potentially interfere the LTE sidelink communication.

In addition, NR sidelink communication can support communication in a PSFCH within each slot. In other words, an NR slot can possibly be divided into NR data transmission and PSFCH transmission, as illustrated in the example of FIG. 7B. Because the received signal power may differ for NR data and PSFCH within a slot, UE 105-1 may need to adjust the power on the receiving antenna by performing AGC in the middle of an LTE subframe, even though only one NR slot overlaps the subframe (as is the case of FIG. 7B). This also can potentially interfere the LTE sidelink communication.

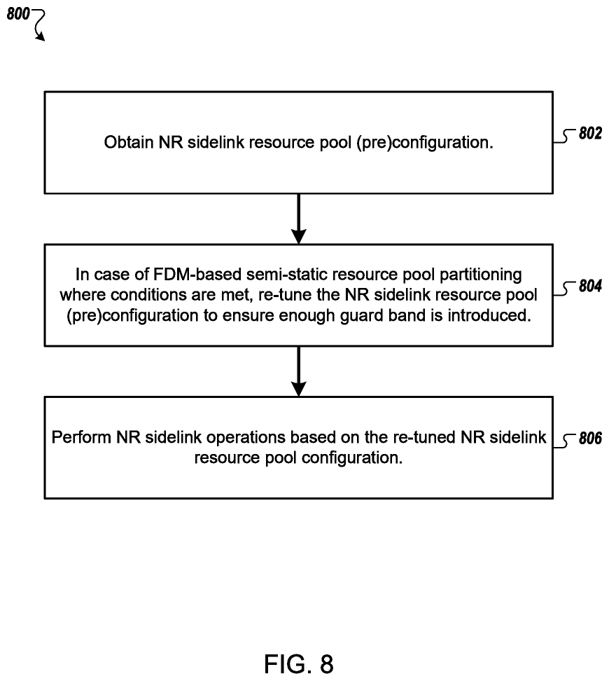

To mitigate the problems in scenarios described above, a guard band can be used to separate the LTE resources and the NR resources, according to some implementations. As shown in FIGS. 7A and 7B, a guard band is introduced to ensure enough frequency-domain separation between the LTE resource pool and the NR resource pool. Typically, the wider the frequency range is covered by a guard band, the more mitigation to the interference is provided by the guard band. Also, interference with different causes may require different sizes/widths of guard band. That is, interference caused by condition (a) multiple NR slots overlapping an LTE subframe may require a different guard band size/width than needed for interference caused by condition (b) an NR slot with PSFCH overlapping an LTE subframe. In scenarios where conditions (a) and (b) are both met for an LTE subframe, the guard band size/width would typically be even greater than scenarios where either condition (a) or condition (b) is met. The introduction and adjustment of the guard band can be autonomously done by the NR communication module, as described below with reference to FIG. 8.

FIG. 8 illustrates an example resource pool re-turning procedure 800 for NR sidelink communication, according to some implementations. At 802, procedure 800 begins with the NR communication module obtaining a configuration or pre-configuration of the NR sidelink resource pool. The NR sidelink resource pool at the beginning may or may not have a guard band configured.

At 804, if the NR sidelink resource pool is selected using FDM-based semi-static resource pool partitioning, and when UE 105-1 realizes that either or both of conditions (a) and (b) are met, UE 105-1 determines to adjust (“re-tune”) the NR sidelink resource pool to ensure enough guard band is present to mitigate the interference to the LTE sidelink communication. The adjustment, or re-tuning, can be done dynamically during the communication by the NR communication module according to specific needs. For example, when the NR communication module determines to enlarge the guard band, the NR communication module can allocate one or more sub-channels to be included in the guard band while using the other sub-channels in the NR sidelink resource pool to perform sidelink communication. Similarly, when the NR communication module determines to reduces the guard band, the NR communication module can remove one or more sub-channels from the existing guard band and add the removed sub-channels to the NR sidelink resource pool for sidelink communication.

At 806, once the NR communication module finishes the adjustment, the NR communication module performs sidelink communication using the resources included in the latest NR sidelink resource pool.

With the features described above, the NR communication module can flexibly adjust the NR sidelink resource pool in FDM-based semi-static resource pool partitioning while reducing interference to LTE sidelink communication caused by AGC.

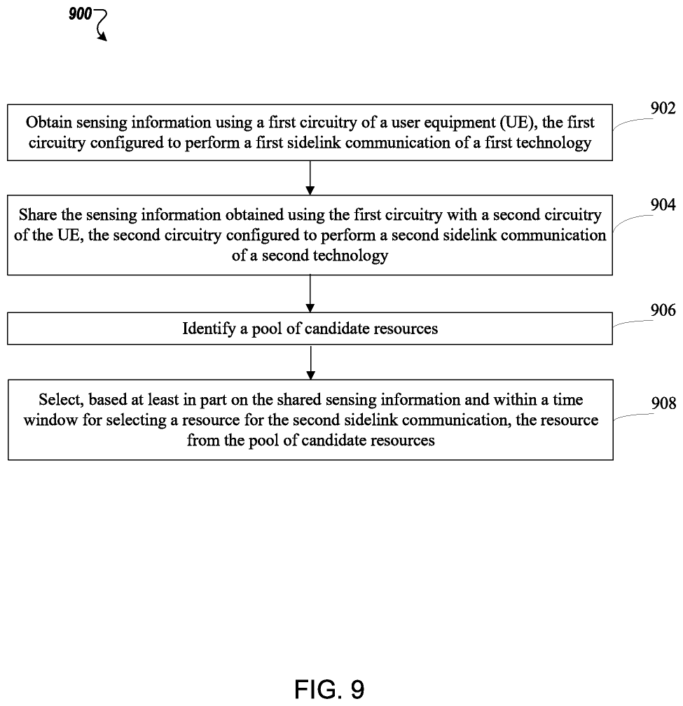

FIG. 9 illustrates a flowchart of an example method 900 of sharing sensing results within a UE for sidelink communications, according to some implementations. Method 900 can be implemented by UE 105-1 of FIG. 1. For example, one or more processors of UE 105-1 can be configured to execute instructions to perform method 900.

At 902, method 900 involves obtaining sensing information using a first circuitry of a UE. The first circuitry can be configured to perform a first sidelink communication of a first technology. For example, the first circuitry can be an LTE communication module configured to perform an LTE sidelink communication.

At 904, method 900 involves sharing the sensing information obtained using the first circuitry with a second circuitry of the UE. The second circuitry can be configured to perform a second sidelink communication of a second technology. For example, the second circuitry can be an NR communication module configured to perform an NR sidelink communication. The sharing may be an intra-UE transmission of LTE sensing results from the LTE communication module to the NR communication module.

At 906, method 900 involves identifying a pool of candidate resources. The candidate resources in the pool can be, e.g., selected to perform the second sidelink communication.

At 908, method 900 involves selecting a resource for the second sidelink communication from the pool of candidate resources. The resource can be selected based at least in part on the shared sensing information and within a time window for selecting the resource. The resource selection of 908 may be based on the shared LTE sensing results only, or may be based on both the shared LTE sensing results and coordination information received from a coordinating UE in the case of IUC. Moreover, the resource selection of 908 may involve semi-static resource pool partitioning or dynamic resource sharing, as previously described with reference to FIGS. 5A-5C.

With the features described above, implementations of method 900 can allow a UE to timely, effectively, and reliably perform NR sidelink communication with co-channel coexistence of LTE sidelink communication.

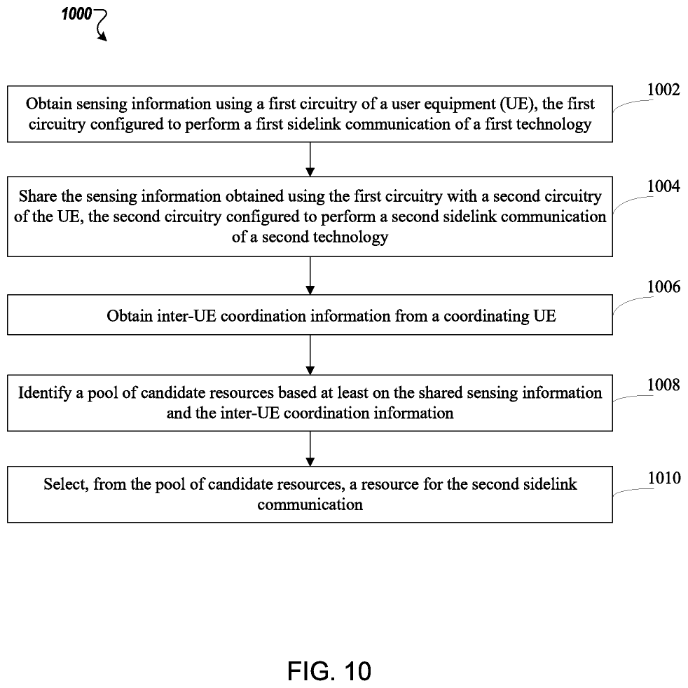

FIG. 10 illustrates a flowchart of an example method 1000 of resource selection based on shared sensing results and IUC information, according to some implementations. Method 1000 can be implemented by UE 105-1 of FIG. 1. For example, one or more processors of UE 105-1 can be configured to execute instructions to perform method 1000.

At 1002, method 1000 involves obtaining sensing information using a first circuitry of a UE. The first circuitry can be configured to perform a first sidelink communication of a first technology. For example, the first circuitry can be an LTE communication module configured to perform an LTE sidelink communication.

At 1004, method 1000 involves sharing the sensing information obtained using the first circuitry with a second circuitry of the UE. The second circuitry can be configured to perform a second sidelink communication of a second technology. For example, the second circuitry can be an NR communication module configured to perform an NR sidelink communication.

At 1006, method 1000 involves obtaining IUC information from a coordinating UE. For example, the coordinating UE can be UE 155 of FIG. 1.

At 1008, method 1000 involves identifying a pool of candidate resources based at least on the shared sensing information and the inter-UE coordination information. For example, the pool of candidate resources can be identified to include resources indicated by the IUC and resources indicated by the shared sensing information.

At 1010, method 1000 involves selecting, from the pool of candidate resources, a resource for the second sidelink communication. For example, the selection can include excluding one or more candidate resources from the pool based on one or more criteria described with reference to FIG. 2. The selection can also consider whether the resource indicated by IUC are preferred. In the event the IUC indicates a preferred resource, the selection can prioritize the preferred resource over other candidate resources in the pool.

With the features of method 1000, a UE can effectively utilize both shared LTE sensing results and received IUC coordination information to select resources for performing NR sidelink communication.

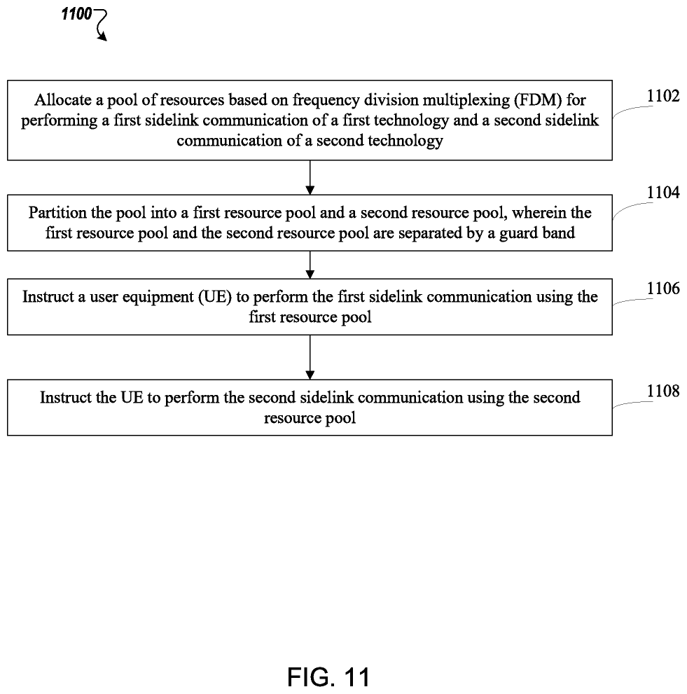

FIG. 11 illustrates a flowchart of an example method 1100 of resource pool partitioning, according to some implementations. Method 1100 can be implemented by UE 105-1 of FIG. 1. For example, one or more processors of UE 105-1 can be configured to execute instructions to perform method 1100.

At 1102, method 1100 involves allocating a pool of resources based on FDM for performing a first sidelink communication of a first technology and a second sidelink communication of a second technology. For example, the first sidelink communication can be an LTE sidelink communication and the second sidelink communication can be an NR sidelink communication. Alternatively, the first sidelink communication can be an NR sidelink communication and the second sidelink communication can be an LTE sidelink communication At 1104, method 1100 involves partitioning the pool into a first resource pool and a second resource pool, wherein the first resource pool and the second resource pool are separated by a guard band. For example, the partitioning at 1104 can be similar to those illustrated in FIGS. 7A and 7B.

At 1106, method 1100 involves instructing a UE to perform the first sidelink communication using the first resource pool. At 1108, method 1100 involves instructing the UE to perform the second sidelink communication using the second resource pool. The performances of the first and the second sidelink communications can be similar to those described with reference to FIG. 1.

With the features of method 1100, the LTE and NR sidelink communications can coexist with reduced interference from each other.

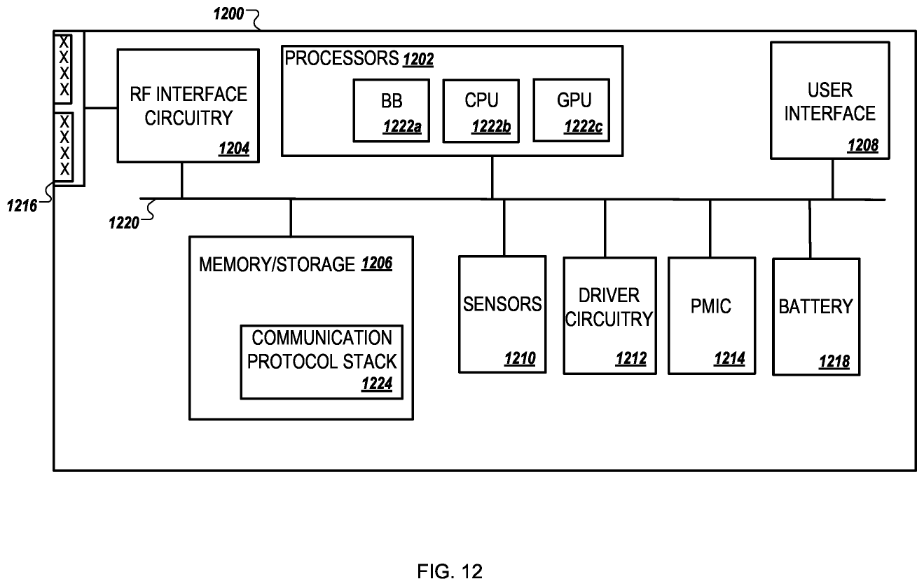

FIG. 12 illustrates a UE 1200, according to some implementations. The UE 1200 may be similar to and substantially interchangeable with UEs 125 and 155 of FIG. 1.

The UE 1200 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1200 may include processors 1202, RF interface circuitry 1204, memory/storage 1206, user interface 1208, sensors 1210, driver circuitry 1212, power management integrated circuit (PMIC) 1214, antenna structure 1216, and battery 1218. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1220, which may represent any type of interface, input/output, bus (local, system, or expansion), transmission line, trace, optical connection, etc. that allows various circuit components (on common or different chips or chipsets) to interact with one another.

The processors 1202 may include processor circuitry such as, for example, baseband processor circuitry (BB) 1222A, central processor unit circuitry (CPU) 1222B, and graphics processor unit circuitry (GPU) 1222C. The processors 1202 may include any type of circuitry or processor circuitry that executes or otherwise operates computer-executable instructions, such as program code, software modules, or functional processes from memory/storage 1206 to cause the UE 1200 to perform operations as described herein.

In some implementations, the processors 1202 includes the LTE communication module and the NR communication module described above with reference to FIGS. 2-9. Both of the LTE communication module and the NR communication module can be physically implemented as hardware circuitry. The LTE communication module and the NR communication module can interact with other components of UE 1200 to perform operations in LTE sidelink communication and NR sidelink communication, respectively. These operations can include those performed by UE 105-1, such as sharing sensing results, selecting sidelink resources, determining availability of a resource, calculating CBR, and re-tuning NR resource configurations, etc.

In some implementations, the baseband processor circuitry 1222A may access a communication protocol stack 1224 in the memory/storage 1206 to communicate over a 3GPP compatible network. In general, the baseband processor circuitry 1222A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1204. The baseband processor circuitry 1222A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM”in the uplink.

The memory/storage 1206 may include one or more non-transitory, computer-readable media that includes instructions (for example, communication protocol stack 1224) that may be executed by one or more of the processors 1202 to cause the UE 1200 to perform various operations described herein. The memory/storage 1206 include any type of volatile or non-volatile memory that may be distributed throughout the UE 1200. In some implementations, some of the memory/storage 1206 may be located on the processors 1202 themselves (for example, L1 and L2 cache), while other memory/storage 1206 is external to the processors 1202 but accessible thereto via a memory interface. The memory/storage 1206 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1204 may include transceiver circuitry and radio frequency front module (RFEM) that allows the UE 1200 to communicate with other devices over a radio access network. The RF interface circuitry 1204 may include various elements arranged in transmit or receive paths. These elements may include, for example, switches, mixers, amplifiers, filters, synthesizer circuitry, control circuitry, etc. In some implementations, the RF interface circuitry 1204 may interact with processors 1202 to perform AGC on received sidelink signals, as mentioned above with reference to FIGS. 7 and 8.

In the receive path, the RFEM may receive a radiated signal from an air interface via antenna structure 1216 and proceed to filter and amplify (with a low-noise amplifier) the signal. The signal may be provided to a receiver of the transceiver that downconverts the RF signal into a baseband signal that is provided to the baseband processor of the processors 1202.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1216. In various implementations, the RF interface circuitry 1204 may be configured to transmit/receive signals in a manner compatible with NR access technologies.

The antenna 1216 may include antenna elements to convert electrical signals into radio waves to travel through the air and to convert received radio waves into electrical signals. The antenna elements may be arranged into one or more antenna panels. The antenna 1216 may have antenna panels that are omnidirectional, directional, or a combination thereof to enable beamforming and multiple input, multiple output communications. The antenna 1216 may include microstrip antennas, printed antennas fabricated on the surface of one or more printed circuit boards, patch antennas, phased array antennas, etc. The antenna 1216 may have one or more panels designed for specific frequency bands including bands in FR1 or FR2.

The user interface 1208 includes various input/output (I/O) devices designed to enable user interaction with the UE 1200. The user interface 1208 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1200.

The sensors 1210 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1212 may include software and hardware elements that operate to control particular devices that are embedded in the UE 1200, attached to the UE 1200, or otherwise communicatively coupled with the UE 1200. The driver circuitry 1212 may include individual drivers allowing other components to interact with or control various input/output (I/O) devices that may be present within, or connected to, the UE 1200. For example, driver circuitry 1212 may include a display driver to control and allow access to a display device, a touchscreen driver to control and allow access to a touchscreen interface, sensor drivers to obtain sensor readings of sensor circuitry 1228 and control and allow access to sensor circuitry 1228, drivers to obtain actuator positions of electro-mechanic components or control and allow access to the electro-mechanic components, a camera driver to control and allow access to an embedded image capture device, audio drivers to control and allow access to one or more audio devices.

The PMIC 1214 may manage power provided to various components of the UE 1200. In particular, with respect to the processors 1202, the PMIC 1214 may control power-source selection, voltage scaling, battery charging, or DC-to-DC conversion.

In some implementations, the PMIC 1214 may control, or otherwise be part of, various power saving mechanisms of the UE 1200. A battery 1218 may power the UE 1200, although in some examples the UE 1200 may be mounted deployed in a fixed location, and may have a power supply coupled to an electrical grid. The battery 1218 may be a lithium ion battery, a metal-air battery, such as a zinc-air battery, an aluminum-air battery, a lithium-air battery, and the like. In some implementations, such as in vehicle-based applications, the battery 1218 may be a typical lead-acid automotive battery.

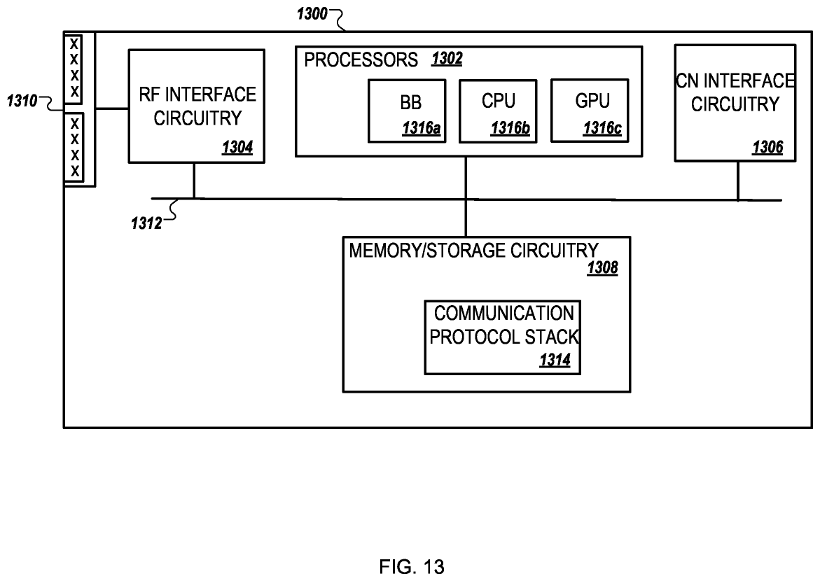

FIG. 13 illustrates an access node 1300 (e.g., a base station or gNB), according to some implementations. The access node 1300 may be similar to and substantially interchangeable with base stations 130. The access node 1300 may include processors 1302, RF interface circuitry 1304, core network (CN) interface circuitry 1306, memory/storage circuitry 1308, and antenna structure 1310.

The components of the access node 1300 may be coupled with various other components over one or more interconnects 1313. The processors 1302, RF interface circuitry 1304, memory/storage circuitry 1308 (including communication protocol stack 1314), antenna structure 1310, and interconnects 1313 may be similar to like-named elements shown and described with respect to FIG. 10. For example, the processors 1302 may include processor circuitry such as, for example, baseband processor circuitry (BB) 1316A, CPU 1316B, and GPU 1316C.

The CN interface circuitry 1306 may provide connectivity to a core network, for example, a 5th Generation Core network (5GC) using a 5GC-compatible network interface protocol such as carrier Ethernet protocols, or some other suitable protocol. Network connectivity may be provided to/from the access node 1300 via a fiber optic or wireless backhaul. The CN interface circuitry 1306 may include one or more dedicated processors or FPGAs to communicate using one or more of the aforementioned protocols. In some implementations, the CN interface circuitry 1306 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1300 that operates in an NR or 5G system (for example, a gNB), and the term “E-UTRAN node” or the like may refer to an access node 1300 that operates in an LTE or 4G system (e.g., an eNB). According to various implementations, the access node 1300 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1300 may be implemented as one or more software entities running on server computers as part of a virtual network, which may be referred to as a CRAN and/or a virtual baseband unit pool (vBBUP). In V2X scenarios, the access node 1300 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,”and the like.

Various components may be described as performing a task or tasks, for convenience in the description. Such descriptions should be interpreted as including the phrase “configured to.” Reciting a component that is configured to perform one or more tasks is expressly intended not to invoke 35 U.S. C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-20. (canceled)

21. One or more processors configured to, when executing instructions stored in a memory, perform operations comprising:
determining sensing information that pertains to a first radio access technology (RAT);
obtaining inter-user equipment (UE) coordination (IUC) information from a peer UE;
identifying a set of candidate resources within a sidelink resource pool associated with a second RAT; and
selecting, from the set of candidate resources in the sidelink resource pool, at least one resource to use for a sidelink transmission based at least on the sensing information and the IUC information.

22. The one or more processors of claim 21, wherein selecting the at least one resource from the set of candidate resources comprises excluding one or more resources from the set of candidate resources based at least on the sensing information and the IUC information.

23. The one or more processors of claim 21, wherein selecting the at least one resource from the set of candidate resources comprises excluding one or more resources from the set of candidate resources based at least on a reference signal received power (RSRP) of the one or more resources.

24. The one or more processors of claim 21, wherein the sensing information indicates one or more sidelink resources that are reserved for sidelink communications associated with the first RAT.

25. The one or more processors of claim 21, wherein selecting the at least one resource from the set of candidate resources comprises determining whether a total number of candidate resources in the sidelink resource pool is greater than a predetermined number after resource exclusion.

26. The one or more processors of claim 21, wherein the IUC information indicates a preferred resource of the peer UE.

27. The one or more processors of claim 26, the operations further comprising determining that the sidelink resource pool comprises the preferred resource.

28. The one or more processors of claim 27, wherein selecting the at least one resource from the set of candidate resources comprises prioritizing the preferred resource over other candidate resources in the sidelink resource pool.

29. The one or more processors of claim 22, wherein the IUC information indicates a non-preferred resource of the peer UE.

30. The one or more processors of claim 29, wherein selecting the at least one resource from the set of candidate resources comprises excluding the non-preferred resource of the peer UE from the set of candidate resources based at least on the IUC information.

31. The one or more processors of claim 21, wherein the first RAT is Long-Term Evolution (LTE) and the second RAT is New Radio (NR).

32. The one or more processors of claim 21, wherein a guard band is configured between the sidelink resource pool associated with the second RAT and a sidelink resource pool associated with the first RAT.

33. The one or more processors of claim 21, wherein the first RAT and the second RAT have different subcarrier spacings.

34. A method comprising:
determining sensing information that pertains to a first radio access technology (RAT);
receiving inter-user equipment (UE) coordination (IUC) information from a peer UE;
identifying a set of candidate resources within a sidelink resource pool associated with a second RAT; and
selecting, from the set of candidate resources in the sidelink resource pool, at least one resource to use for a sidelink transmission based at least on the sensing information and the IUC information.

35. The method of claim 34, wherein selecting the at least one resource from the set of candidate resources comprises excluding one or more resources from the set of candidate resources based at least on the sensing information and the IUC information.

36. The method of claim 34, wherein selecting the at least one resource from the set of candidate resources comprises excluding one or more resources from the set of candidate resources based at least on a reference signal received power (RSRP) of the one or more resources.

37. The method of claim 34, wherein the sensing information indicates one or more sidelink resources that are reserved for sidelink communications associated with the first RAT.

38. The method of claim 34, wherein selecting the at least one resource from the set of candidate resources comprises determining whether a total number of candidate resources in the sidelink resource pool is greater than a predetermined number after resource exclusion.

39. The method of claim 34, wherein the IUC information indicates a preferred resource of the peer UE.

40. user equipment (UE) configured to perform operations comprising:
determining sensing information that pertains to a first radio access technology (RAT);
receiving inter-user equipment (UE) coordination (IUC) information from a peer UE;
identifying a set of candidate resources within a sidelink resource pool associated with a second RAT; and
selecting, from the set of candidate resources in the sidelink resource pool, at least one resource to use for a sidelink transmission based at least on the sensing information and the IUC information.
